(19) United States
(12) Patent Application Publication
(10) Pub. No.: US 2026/0059492 A1
(43) Pub. Date: Feb. 26, 2026

(54) MANAGING PAGING FOR MULTICAST SERVICES

(71) Applicant: GOOGLE LLC, Mountain View, CA (US)

(72) Inventor: Chih-Hsiang Wu, Taoyuan City (TW)

(21) Appl. No.: 19/104,319

(22) PCT Filed: Aug. 16, 2023
(86) PCT No.: PCT/US2023/030405

§ 371 Date: Feb. 17, 2025

Related U.S. Application Data
(60) Provisional application No. 63/371,632, filed on Aug. 16, 2022.

(51) Int. Cl. H04W 68/00; H04L 12/18; H04W 76/11; H04W 76/20

(52) U.S. Cl. CPC H04W 68/005; H04L 12/189; H04W 76/11; H04W 76/20

(57) ABSTRACT

A paging method is implemented in a node of a radio access network (RAN) and comprises receiving a message including an identifier of a multicast and/or broadcast services (MBS) session; and in response to determining that the message includes a paging list, paging a user equipment (UE) using information in the message.

### CROSS-REFERENCE TO RELATED TO APPLICATION

This application claims priority to and the benefit of the filing date of provisional U.S. Patent Application No. 63/371,632, entitled “Managing Paging for Multicast Services,” filed on Aug. 16, 2022. The entire contents of the provisional application are hereby expressly incorporated herein by reference.

### FIELD OF THE DISCLOSURE

This disclosure relates to wireless communications and, more particularly, to paging UEs for one or more multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety.

To provide multicast and/or broadcast service (MBS), a base station can configure plural UEs with a common frequency resource (CFR) and a physical downlink control channel (PDCCH) configuration configuring a group common PDCCH. The base station can assign a group common radio network temporary identifier (RNTI) to these UEs to receive physical downlink shared channel (PDSCH) transmissions including MBS data packet(s). Then the base station can send a downlink control information (DCI) with a cyclic redundancy check (CRC) scrambled by the group common RNTI on a group common PDCCH to schedule a PDSCH transmission including MBS data packet(s).

When there is (usually temporarily) no data for the RAN to send to the UEs for a multicast MBS session, the RAN may transition the UEs to the RRC_IDLE or RRC_INACTIVE state. When the CN activates the multicast MBS session, the RAN notifies the UEs in the RRC IDLE or INACTIVE state by transmitting a paging message for the multicast MBS session. Upon receiving the paging message, the UEs reconnect to the RAN and transition to the RRC_CONNECTED state.

However, it is not clear how the RAN determines paging occasion(s) and paging frame(s) for transmitting the paging message. It is also unclear how the CN pages UEs operating in different 5GMM modes for a multicast MBS session. Furthermore, according to the current 3GPP specifications 24.501, the UE responds to paging for an MBS session (e.g., a paging indication including a Temporary Mobile Group Identity (TMGI)) when the UE operates in the 5GMM-IDLE mode. However, when the UE in the 5GMM-CONNECTED mode and an RRC inactive indication receives paging for an MBS session, the UE does not respond to the paging. As a result, the UE is unable to receive MBS data of the MBS session.

Further, when the UE in the 5GMM-CONNECTED mode and an RRC inactive indication receives a paging message for an MBS session, the UE in some cases transitions to the 5GMM-IDLE mode because the UE cannot determine whether the paging message including an MBS session ID is a RAN paging message or an AMF paging message.

Still further, when the base station is distributed and accordingly includes a central unit (CU) and at least one distributed unit (DU), it is not clear how the DU determines paging occasions and/or paging frames in response to an interface message referencing an MBS session.

### SUMMARY

An example embodiment of the techniques of this disclosure is a paging method implemented in a node of a radio access network (RAN). The method includes receiving a message including an identifier of a multicast and/or broadcast services (MBS) session; and in response to determining that the message includes a paging list, paging a user equipment (UE) using information in the message.

Another example embodiment of these techniques is a a radio access network (RAN) node comprising a transceiver; and processing hardware configured to implement the method above.

### BRIEF DESCRIPTION OF THE DRAWINGS

FIG. 1A is a block diagram of an example wireless communication system in which a RAN and/or a UE implement the techniques of this disclosure for managing transmission and reception of MBS;

FIG. 1B is a block diagram of an example base station including a central unit (CU) and a distributed unit (DU) that can operate in the system of FIG. 1A;

FIG. 2A is a block diagram of an example protocol stack according to which the UE of FIGS. 1A-B can communicate with base stations;

FIG. 2B is a block diagram of an example protocol stack according to which the UE of FIGS. 1A-B can communicate with a DU and a CU of a base station;

FIG. 3-4 example message sequences in which a base station transmits one or more paging messages to page UEs operating an inactive for an MBS session and the UEs activate MBS reception to receive the MBS session in response to receiving the paging message;

FIGS. 5-9C are flow diagrams of example methods for paging UEs for an MBS session, which can be implemented by a core network (CN) node;

FIGS. 10-13B are flow diagrams of example methods for paging UEs for an MBS session, which can be implemented by one or multiple RAN nodes (e.g., a non-distributed base station or a distributed base station including a CU and a DU);

FIGS. 14-15 are flow diagrams of example methods for receiving a paging message for an MBS session, which can be implemented by a UE.

### DETAILED DESCRIPTION OF THE DRAWINGS

Generally speaking, the techniques of this disclosure allow UEs to receive MBS information via radio resources allocated by a base station of a RAN. To this end, the base station can configure different radio resources in one or multiple overlapping cells to multicast or broadcast MBS data (and associated control information) and/or unicast non-MBS data (and associated control information) with one or multiple UEs on the downlink (DL). Note that “transmit” by a base station may interchangeably refer to “multicast”, “broadcast”, and/or “unicast.” The base station can also unicast MBS data (and associated control information) to a UE on a dedicated DRB for the UE. The one or more multiple UEs can transmit non-MBS data to the base station on the uplink (UL).

Accordingly, a base station of this disclosure can configure one or more radio bearers to transmit MBS information (i.e., MBS data packets and/or control information) to a UE. A radio bearer that carries MBS information to the UE can be a unicast DRB (i.e., a dedicated DRB for the UE) or a multicast DRB (i.e., a DRB that may be shared by multiple UEs, also referred to as an MBS radio bearer or MRB). For example, the base station can transmit unicast configuration parameters or multicast configuration parameters to the UE to configure the UE to receive MBS information via a unicast DRB or a multicast DRB, respectively. As used in this disclosure, the term DRB may refer to a unicast DRB or a multicast DRB, unless specifically noted otherwise.

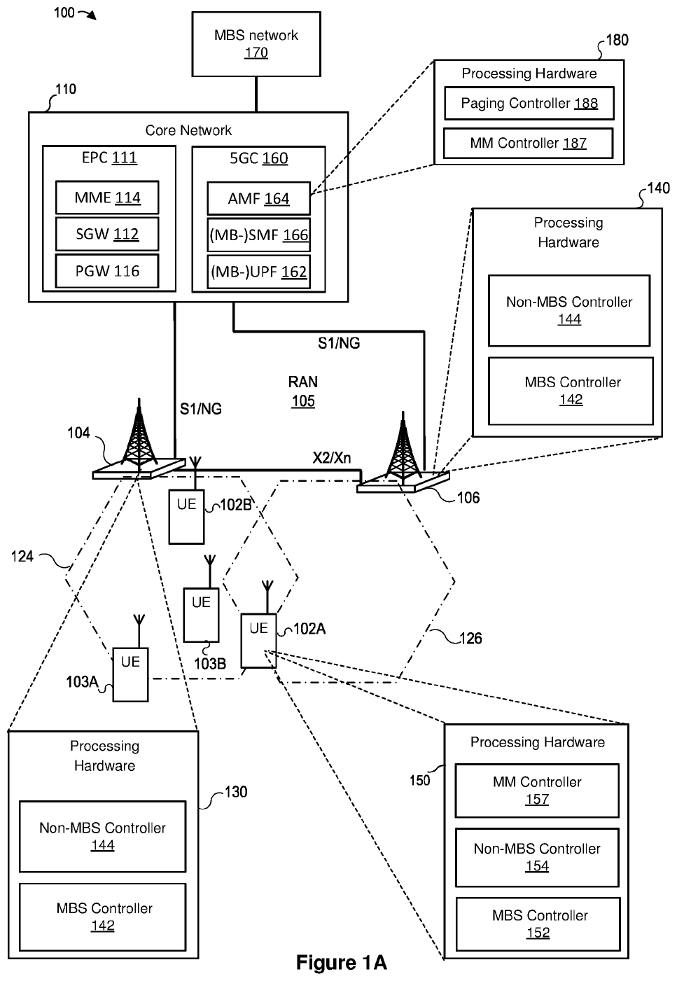

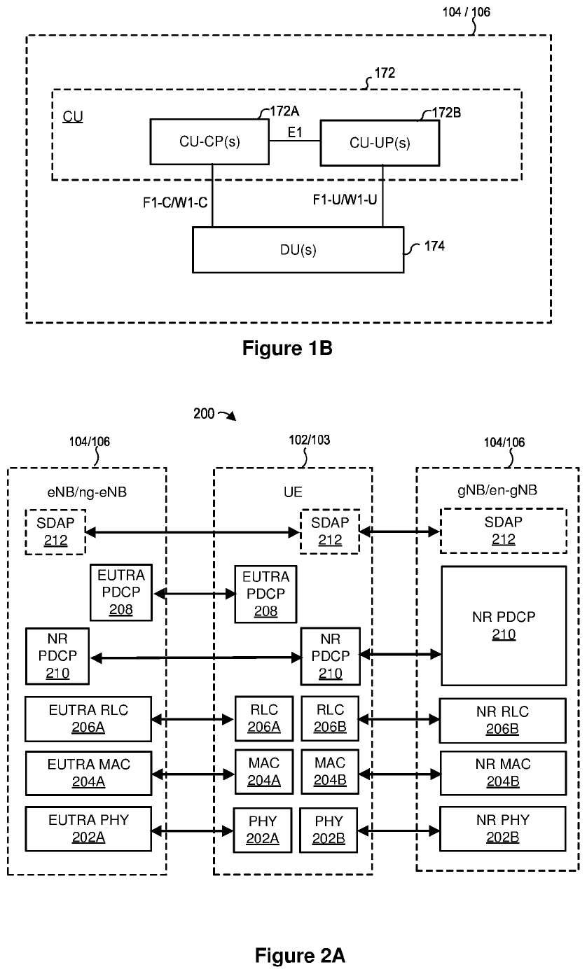

FIG. 1A depicts an example wireless communication system 100 that can implement MBS operation techniques of this disclosure. The wireless communication system 100 includes UE 102A, UE 102B, UE 103A, UE 103B as well as base stations 104, 106 of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. Similarly, UE 103 is used herein to represent the UE 103A, the UE 103B, or both the UE 103A and UE 103B, unless otherwise specified. The base stations 104, 106 can be any suitable type, or types, of base stations, such as an evolved node B (eNB), a next-generation eNB (ng-eNB), a 5G Node B (gNB) or a 6G base station, for example. As a more specific example, the base station 104 can be an eNB or a gNB, and the base station 106 can be a gNB.

The base station 104 supports a cell 124, and the base station 106 supports a cell 126. The cell 124 partially overlaps with cell 126, such that the UE 102 and UE 103 can be in range to communicate with base station 104. The UE 102A can simultaneously being in range to communicate with base station 106 (or in range to detect or measure the signal from both base stations 106). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the uplink (UL) direction (i.e., from the UE 102 to a base station) and/or downlink (DL) direction (i.e., from a base station to the UE 102). In non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UF 102 can be in a connected state. Alternatively, the UF 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UF 102) to the UF 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s) such as common frequency resources (CFR)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can refrain from applying a security key to MBS data and transmit the MBS data on the radio bearer. Correspondingly, the UE 102 can omit applying a security key to MBS data received on the radio bearer. The UE 102 can apply an application-level security key, received from the CN 110 or an MBS server, to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS information received from the CN 110 or an edge server. For example, the base station MBS controller 132 can be configured to support Radio Resource Control (RRC) configurations, procedures and messaging associated with MBS procedures, and/or to support the necessary operations (e.g., MBS activation notification or multicast paging), as discussed below. The processing hardware 130 can include a base station non-MBS controller 134 configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS information received from the CN 110 or an edge server. For example, the base station MBS controller 142 can be configured to support RRC configurations, procedures and messaging associated with MBS procedures, and/or to support the necessary operations (e.g., MBS activation notification), as discussed below. The processing hardware 140 can include a base station non-MBS controller 144 configured to manage or control one or more RRC configurations and/or RRC procedures when the base station 106 operates as an MN or SN during a non-MBS operation.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS information. For example, the UE MBS controller 152 can be configured to support RRC configurations, procedures and messaging associated with MBS procedures, and/or to support the necessary operations (e.g., MBS activation notification), as discussed below. The processing hardware 150 can include a UE non-MBS controller 154 configured to manage or control one or more RRC configurations and/or RRC procedures in accordance with any of the implementations discussed below, when the UE 102 communicates with an MN and/or an SN during a non-MBS operation.

The CN 110 can be an evolved packet core (EPC) 111 or a fifth-generation core (5GC) 160, both of which are depicted in FIG. 1A. The base station 104 can be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only. In cases where the SMF 166 is dedicated for MBS, the SMF 166 is a multicast and/or broadcast MB-SMF. In cases where the UPF 162 is dedicated for MBS, the UPF 162 is a multicast and/or broadcast MB-UPF

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an MeNB, an Mng-eNB, an MgNB, an SgNB, or an Sng-eNB. The UE 102 can communicate with the base station 104 and the base station 106 via the same radio access technology (RAT), such as EUTRA or NR, or via different RATs.

When the base station 104 is an MeNB and the base station 106 is an Sg.VB, the UE 102 can be in EN-DC with the MeNB 104 and the SgNB 106. When the base station 104 is an Mng-eNB and the base station 106 is an SgNB, the UE 102 can be in next generation (NG) EUTRA-NR DC (NGEN-DC) with the Mng-eNB 104 and the SgNB 106. When the base station 104 is an MgNB and the base station 106 is an SgNB, the UE 102 can be in NR-NR DC (NR-DC) with the MgNB 104 and the SgNB 106. When the base station 104 is an MgNB and the base station 106A is an Sng-eNB, the UE 102 can be in NR-EUTRA DC (NE-DC) with the MgNB 104 and the Sng-e NB 106.

With continued reference to FIG. 1A, the CN 110 communicatively connects the UE 102, to an MBS network 170, via the RAN 105. The MBS network 170 can provide to the UE 102 multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety. To this end, an entity (e.g., a server or a group of servers) operating in the MBS network 170 supports packet exchange with the UE. The packets can convey signaling (such as session initiation protocol (SIP) messages, IP messages, or other suitable messages) as well as data (“or media”) such as text messages, audio and/or video.

FIG. 1B depicts an example, distributed implementation of any one or more of the base stations 104, 106. In this implementation, the base station 104 or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

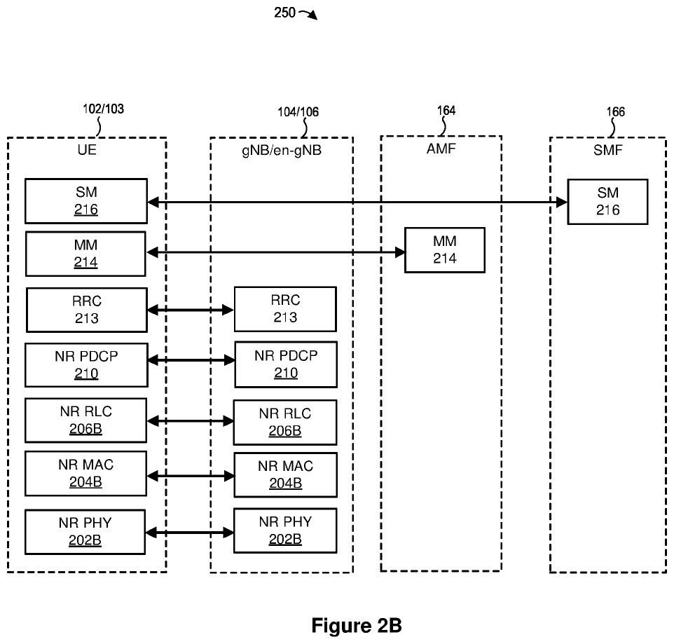

FIG. 2A illustrates, in a simplified manner, an example protocol stack 200 according to which the UE 102 or 103 can communicate with an eNB/ng-eNB or a gNB (e.g., one or more of the base stations 104 and 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. The NAS messages can include mobility management (MM) and session management (SM) messages. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106 operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

In some implementations, a base station (e.g., base station 104 or 106) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RIC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

FIG. 2B illustrates, in a simplified manner, an example protocol stack 250, similar to the example stack 200, except that the protocol stack 250 includes an RRC sublayer 213, an MM sublayer 214 and a SM sublayer 216.

In the example stack 250, a UE (e.g., the UE 102 or 103) communicates with a gNB (e.g., the base station 104 or 106) similar to the example stack 200. The UE and gNB communicates RRC messages with one another via the RRC sublayer 213. The UE communicates with an AMF (e.g., A.MF 164) via the gNB and MM sublayer 214, and communicate with an SMF (e.g., SMF 166) via the gNB, AMF and SM sublayer 216. The UE and AMF communicates MM messages and the UE and SMF communicates SM messages.

The RRC sublayer 214 provides RRC procedures that the UE and gNB perform with one another. The RRC procedures include procedures for RRC connection establishment, security activation, RRC reconfiguration (e.g., setup, modification and/or release of SRB(s) and DRB(s), and/or configuration and/or reconfiguration of PHY, MAC and RLC configuration parameters), measurement configuration and reporting, and/or RRC connection release. The RRC sublayer 213 also provide transport services to the MM sublayer 214. Thus, each MM message is carried in an RRC message communicated between the UE and gNB. The MM sublayer 214 provides MM procedures that the UE and AMF perform with one another. The MM procedures include procedures for registration, tracking are update, UE authentication, and control integrity protection and ciphering, temporary identity allocation, and/or UE capability reporting. The SM sublayer 216 provides SM procedures that the UE and SMF perform with one another. The SM procedures include procedures for PDU session establishment, PDU session modification, PDU session release, MBS session join, and/or MBS session leave. The MM sublayer 214 also provides transport services to the SM sublayer 216. Thus, each SM message is carried in an MM message communicated between the UE and AMF.

There are two modes defined in the MM sublayer 214: MM-IDLE mode and MM-CONNECTED mode. The MM-IDLE mode defines a state when the UE does not have a signaling connection (i.e., NAS signaling connection) with the AMF, and the MM-CONNECTED mode defines a state that the UE has a signaling connection with the AMF. In some implementations, if the UE operates in the MM-CONNECTED mode in the MM sublayer 214 and operates in an RRC_INACTIVE state, the UE operates in the MM-CONNECTED with an RRC inactive indication in the MM sublayer 214. In some implementations, if the UE operates in the MM-CONNECTED mode in the MM sublayer 214 and operates in an RRC_CONNECTED state, the UE operates in the MM-CONNECTED mode in the MM sublayer 214 (i.e., the UE operates in the MM-CONNECTED mode without an RRC inactive indication). In the following description, the MM-CONNECTED represents that the MM-CONNECTED mode without an RRC inactive indication or the MM-CONNECTED mode with the RRC_CONNECTED state.

In some implementations, the MM sublayer 214 and SM sublayer 216 are a 5GMM sublayer and a 5GSM sublayer, respectively. In some implementations, the MM-IDLE and MM-CONNECTED modes are 5GMM-IDLE mode and 5GMM-CONNECTED mode, respectively.

In some implementations, the MM-IDLE (e.g., 5GMM-IDLE) and MM-CONNECTED (e.g., 5GMM-CONNECTED) are equivalent to connection management (CM)-IDLE and CM-CONNECTED, respectively.

To simplify the following description, the UE 102 represents the UE 102A and the UE 102B, and the UE 103 represents the UE 103A and the UE 103B, unless explicitly described.

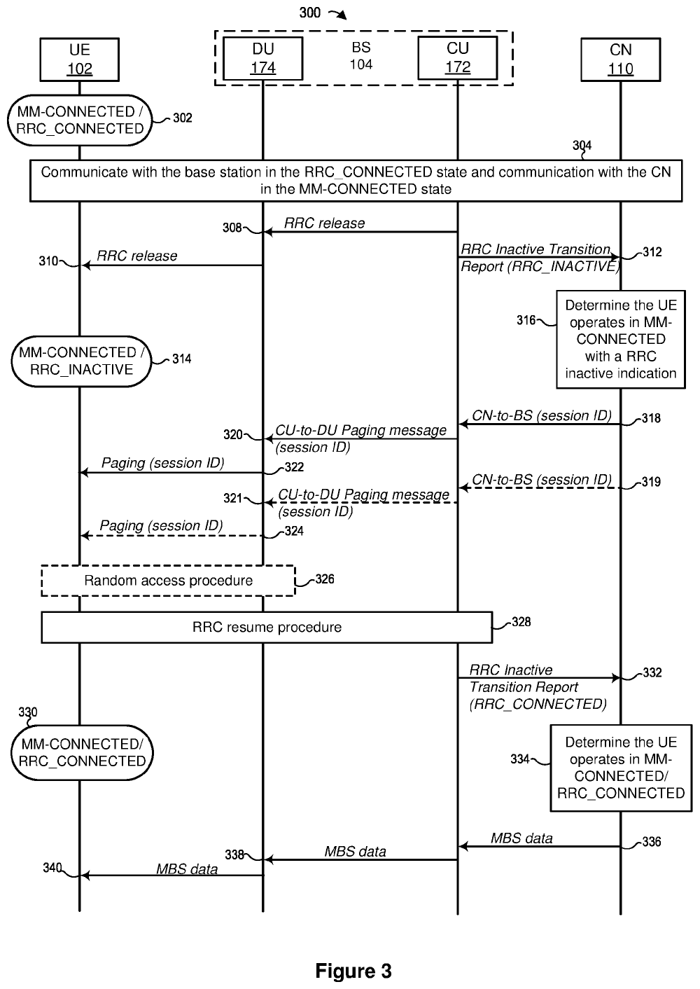

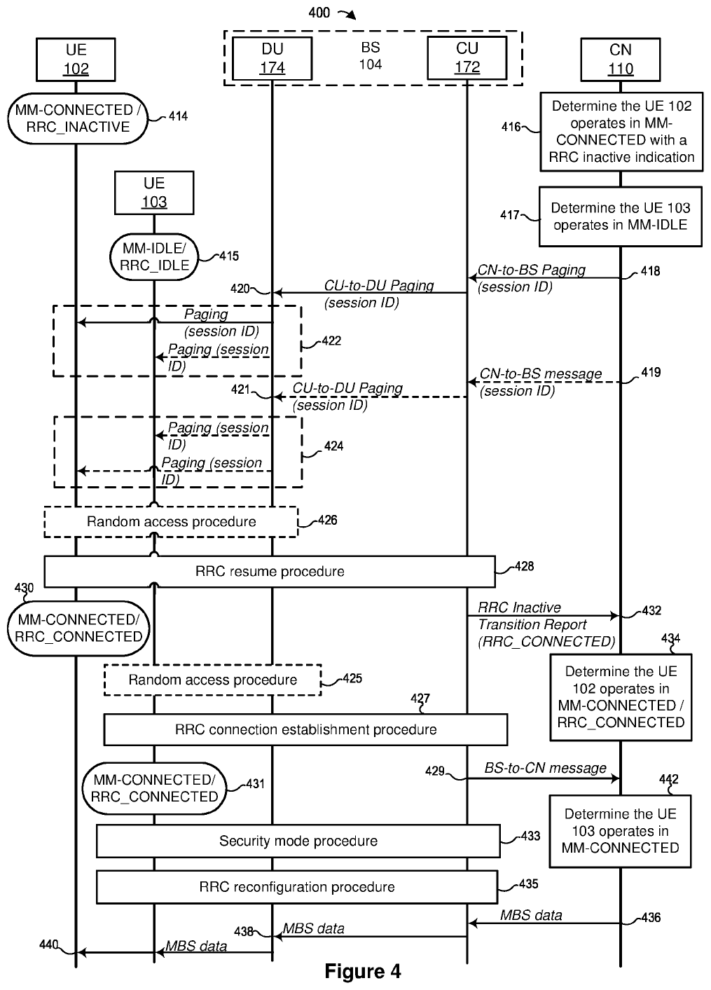

FIGS. 3 and 4 are messaging diagrams of example scenarios in which one or more UEs, the RAN, the CN, and the MBS network implement the techniques of this disclosure for managing MBS transmission and reception. Generally speaking, events in FIGS. 3 and 4 that are similar are labeled with similar reference numbers, with differences discussed below where appropriate. Except for the differences shown in the figures and discussed below, any on the alternative implementations discussed with respect to a particular event (e.g., for messaging and processing) may apply to events labeled with similar reference numbers in other figures.

Referring first to FIG. 3, the base station 104 in an example scenario 300 includes a central unit (CU) 172 and a distributed unit (DU) 174. The UE 102 initially operates 302 in an MM-CONNECTED mode and an RRC_CONNECTED state. The UE 102 in the RRC_CONNECTED state communicates 304 control signals and PDUs with the base station 104, using multiple configuration parameters. The UE 102 in the MM-CONNECTED mode communicates 304 data (e.g., NAS messages and/or user-plane data) with the CN 110 via the base station 104. In some implementations, the PDUs can include RRC PDUs, PDCP PDUs and/or SDAP PDUs. In other implementations, the PDUs can include the NAS message and/or user-plane data.

In some implementations, the configuration parameters include configuration parameters related to operations of RRC and/or PDCP protocol layers (e.g., RRC 214 and/or NR PDCP 210), which the UE 102 and CU 172 use to communicate with one another. In some implementations, the configuration parameters include configuration parameters in a RadoBearerConfig information element (IE) and/or MeasConfig 1E defined in 3GPP specification 38.331.

In some implementations, the configuration parameters include configuration parameters related to operations of RRC, RLC, MAC, and/or PHY protocol layers (e.g., RLC 206B, MAC 204B and/or PHY 202B), which the UE 102 and DU 174 use to communicate with one another while the UE 102. In some implementations, the configuration parameters include configuration parameters in a CellGroupConfig 1E defined in 3GPP specification 38.331.

In some implementations, the UE 102 operates in the MM-IDLE mode prior to the event 302, and the UE 102 performs a NAS procedure with the CN 110 via the base station 104 to establish a NAS signaling connection with the CN 110 (e.g., AMF 164). Upon successfully establishing the NAS signaling connection, the UE 102 transitions to the MM-CONNECTED mode from the MM-IDLE mode.

While the UE 102 communicates with the base station 104, the CU 172 can determine to transition the UE 102 from the connected state to an inactive state, based for example on data inactivity of the UE 102 (i.e., the UE 102 in the connected state has no data activity with the base station 104). In some implementations, the CU 172 implements a control-plane entity CU-CP (e.g., CU-CP 172A) and a user-plane entity CU-UP (e.g., CU-UP 172B), and the CU-CP makes the determination to transition the UE 102 to the inactive state. In some implementations, the CU 172 (or the CU-CP) can determine that the UE 102 is in data inactivity based on UE assistance information received from the UE 102 and/or an inactivity notification received from the DU 174, and/or an inactivity notification received from the CP-UP. After a certain period of data inactivity, the CU 172 can determine that neither the CU 172 nor the UE 102 has transmitted any data in the downlink direction or the uplink direction, respectively, during a certain period. In response to the determination, the CU 172 can determine to transition the UE 102 to the inactive state.

In response to determining to transition the UE 102 to the inactive state, the CU 172 can generate an RRC release message (e.g., RRC Release message or RRCConnectionRelease message) to transition the UE 102 to an RRC_INACTIVE state. In some implementations, the CU 172 includes a SuspendConfig 1E to indicate the UE 102 to transition to the RRC_INACTIVE state. In some implementations, the CU 172 generates a PDCP PDU including the RRC release message. The CU 172 then sends 308 to the DU 174 a CU-to-DU message (e.g., a (JE Context Release Command message, a UJE Context Modification Request message or a DI. RRC Message Transfer message) which includes the RRC release message or the PDCP PDU. In turn, the DU 174 transmits 310 the RRC release message to the UE 102. In some implementations, the DU 174 generates a MAC PDU including the RRC release message. The RRC release message instructs the UE 102 to transition to the inactive state.

Upon receiving the RRC release message, the UE 102 transitions 314 to the RRC_INACTIVE state from the RRC_CONNECTED state and transitions 314 to the MM-CONNECTED mode with an RRC inactive indication from the MM-CONNECTED mode (i.e., without an RRC inactive indication). After transitioning to the RRC_INACTIVE state and the MM-CONNECTED mode with an RRC inactive indication, the UE 102 camps on a cell (e.g., cell 124). In the case of the PDCP PDU, the DU 174 generates an RLC PDU including the PDCP PDU, generates a MAC PDU including the RLC PDU, and transmits 310 the MAC PDU to the UE 102. In some implementations, the UE 102 can retain a first portion or all of the configuration parameters in response to the RRC release message, and the CU 172 also retains the first portion or all of the configuration parameters. The UE 102 and CU 172 may release a second portion of the configuration parameters. The DU 174 can send a DU-to-CU message (e.g., a UE Context Release Complete message or a UJE Context Modification Response message) to the CU 172 in response to the CU-to-DU message.

After, or in response to, transitioning the UE 102 to the RRC_INACTIVE state, the CU 172 transmits 312 to the CN 110 an RRC_Inactive Transition Report message, indicating the UE 102 enters the RRC_INACTIVE state. The CN 110 determines 316 that the UE 102 operates in the MM-CONNECTED mode with an RRC inactive indication. At a later time, the CN 110 can notify the UEs of activation of an MBS session. To notify the UEs of the MBS session activation, the CN 110 generates a CN-to-BS message including an MBS session ID and sends 318 the CN-to-BS message to the RAN 105. The MBS session ID identifies the MBS session. In some implementations, the CN-to-BS message of the event 318 can be a next generation application protocol (NGAP) message defined in 3GPP specification 38.413. For example, the NGAP message is a Multicast Group Paging message. In another example, the NGAP message is a Multicast Activation Request message.

Upon receiving 318 the CN-to-BS message, the CU 172 extracts the MBS session ID from the CN-to-BS message, generates a CU-to-DU message including the MBS session ID, and transmits 320 a CU-to-DU Paging message to the DU 174. In some implementations, the CU-to-DU Paging message is an F1 application protocol (F1AP) Multicast Group Paging message. Upon receiving 320 the CU-to-DU Paging message, the DU 174 generates a paging message (e.g., an RRC Paging message) including the MBS session ID. The DU 174 transmits (e.g., via a broadcast) 322 the paging message in at least one first paging occasion (PO) in at least one first paging frame (PF) on the cell to page one or more UEs, after (e.g., in response) to the CU-to-DU Paging message of the event 320. In some implementations, the DU 174 determines the first PO(s) and first PF(s) for UEs operating in one of the RRC_IDLE and RRC_INACTIVE states.

In some implementations, the DU 174 determines a PF and a PO in accordance with the following formulas:
SFN for a PF is given by:

$$( S F N + PF\_offset ) mod T = ( T div N ) * ( UE\_ID mod N )$$

Index (i_s), indicating an index of a PO is given by:

$$i\_s = floor ( UE\_ID / N ) mod Ns ,$$

where T is discontinuous reception (DRX) cycle of a UE (e.g., the UE 102) operating in an RRC_IDLE state or the RRC_INACTIVE state.

If extended DRX (eDRX) is not configured for the UE, the DU 174 can determine T by the shortest of the UE specific DRX value(s), if configured by RRC (e.g., an RRC release message) and/or upper layers or provided in PC5-RRC signaling in case of a L2 U2N Relay UE, and a default DRX value broadcast in system information. In the RRC_IDLE state, if a UE-specific DRX is not configured by upper layers, the DU 174 can apply the default value.

In the RRC_IDLE state, if upper layers configure eDRX for the UE, i.e., T_{eDRX,CN}:

- If T_{eDRX, CN} is no longer than 1024 radio frames T = T_{eDRX, CN};
- else:

| | |
|---|---|
| • | During CN configured PTW, the DU 174 can determine T the |
| | shortest of UE-specific DRX values, if configured by upper layers, |
| | and the default DRX value broadcast in system information. |

In the RRC_INACTIVE state, if eDRX is configured by RRC (e.g., the base station 104), i.e., T_{eDRX,RAN}, and/or by upper layers, i.e., T_{eDRX,CN}:
If both T_{eDRX,CN} and T_{eDRX,RAN} are no longer than 1024 radio frames, T=min {T_{eDRX,RAN}, T_{eDRX,CN}}.
If T_{eDRX,CN} is no longer than 1024 radio frames and no T_{eDRX,RAN} is configured, Tis determined by the shortest of UE specific DRX value configured by RRC and T_{eDRX,CN}.
If T_{eDRX,CN} is longer than 1024 radio frames:
If T_{eDRX,RAN} is not configured:
   During CN configured PTW, T is determined by the shortest of the UE specific DRX value(s), if configured by RRC and/or upper layers, and a default DRX value broadcast in system information. Outside the CN configured PTW, T is determined by the UE specific DRX value configured by RRC;
else if T_{eDRX,RAN} is no longer than 1024 radio frames:
   During CN configured PTW, T is determined by the shortest of the UE specific DRX value, if configured by upper layers and T_{eDRX,RAN}, and a default DRX value broadcast in system information. Outside the CN configured PTW, T is determined by the T_{eDRX,RAN}.

```
N: number of total paging frames in T
Ns: number of paging occasions for a PF
PF_offset: offset used for PF determination
UE ID (e.g., 5G-S-TMSI):
  If an eDRX cycle is configured by RRC or upper layers and
  eDRX-Allowed is signalled in SIB1 (e.g., broadcast on the cell (e.g.,
  cell 124)):
  - UE ID mod 4096
  else:
  - UE ID mod 1024
```

A PF is a Radio Frame and can contain one or multiple PO(s). A PO can include one or more PDCCH monitoring occasions and can consist of one or multiple time slots (e.g. subframe or OFDM symbol) where the DU 174 can transmit paging DCI(s). The DU 174 can transmit (e.g., via a broadcast) system information to configure the UE 102 to monitor one or more PDCCH monitoring occasions in a PO. For example, the system information can include a search space configuration (e.g., pagingSearchSpace) and/or PDCCH monitoring configuration(s) (e.g., firstPDCCH-MonitoringOccasionOfPO and nrofPDCCH-MonitoringOccasionPerSSB-InPO).

In the description above, the term “upper layers” can refer to the MM sublayer 214 or CN 110, and the “RRC” can represent the RRC sublayer 213 or the RRC. In some implementations, the DU 174 determines the at least one first paging occasion for UEs operating in one of the RRC_IDLE state and UEs operating in RRC_INACTIVE state.

The DU 174 can determine the first PO(s) and first PF(s) using a first UE identity index value (i.e., as “UE ID” in the formulas above), a first paging DRX cycle value (i.e., as “T” in the formulas above) and the formulas described above. In some implementations, the CU 172 can include a first UE identity list for paging in the CU-to-DU Paging message. The first UE identity list for paging can include on or more items. In some implementations, the CU 172 can include the first UE identity index value and the first paging DRX value in a first item of the one or more items. In some implementations, the CU 172 receives a first UF paging list from the CN 110, e.g., in the CN-to-BS message of the event 318, and the first UE paging list includes the first UE identity index value and first paging DRX cycle value. In other implementations, the CU 172 determines the first UE identity index value based on a first UE ID of the UE 102A. For example, the CU 172 sets the first UE identity index value to the first UE ID. In another example, the CU 172 uses a formula to derive the first UE identity index value with the first UE ID as an input of the formula. In one implementation, the CU 172 receives the first UE ID from the UE 102A in an RRC message (e.g., RR (′SetupComplete message). In another implementation, the CU 172 receives from the CN 110 a CN-to-BS message (e.g., a NGAP message or a (JE Information Transfer message) including the first UE ID other than the CN-to-BS message of the event 318. In one implementation, the CU 172 receives from the CN 110 a CN-to-BS message including the first paging DRX cycle value other than the CN-to-BS message of the event 318. For example, the CN-to-BS message is a NGAP message such as an Initial Context Setup Request message, a UJE Context Modification Request message, Handover Request message, or a Path Switch Request Acknowledge message. In one implementation, the first paging DRX cycle value is a UE specific DRX cycle value of the UE 102A that the CU 172 receives from the CN 110. In another implementation, the first paging DRX cycle value is a default paging DRX cycle value that the base station 104 uses or configures to page UEs.

In other implementations, the CU 172 receives from another base station (i.e., a second base station such as the base station 106) a BS-to-BS message including the first UE ID and/or first paging DRX cycle value. For example, the BS-to-BS message is an Xn application protocol (XnAP) message such as Handover Request message or Retrieve UE Context Response message. In one implementation, the first paging DRX cycle value is a UE specific DRX cycle value of the UE 102A that the second base station receives from the CN 110. In another implementation, the first paging DRX cycle value is a default paging DRX cycle value that the second base station (e.g., the base station 106) uses or configures for paging UEs. In yet another implementation, the first paging DRX cycle value is a RAN paging cycle value that the second base station (e.g., the base station 106) uses or configures for the UE 102A.

In yet other implementations, the CU 172 determines the first paging DRX cycle value and includes the first paging DRX cycle value in the RRC release message of the event 308. In such implementations, the first paging DRX cycle value is a RAN paging cycle value. In yet other implementations, the CU 172 determines the first paging DRX cycle value as a minimum of the default paging DRX cycle value, the RAN paging cycle value, and/or the UE specific DRX cycle value.

In some alternative implementations, the DU 174 receives the first UE identity index value and/or the first paging DRX cycle value from an Operations, Administration and Maintenance (OAM) node instead of the CU 172.

In some implementations, the DU 174 pre-configures (e.g., pre-stores or pre-determines) one or more UE identity index values and/or one or more paging DRX cycle values. The DU 174 determines the first PO(s) and first PF(s) using the pre-configured UE identity index value(s), the pre-configured DRX cycle value(s) and the formulas described above. In some implementations, the DU 174 does so because the CU-to-DU Paging message of the event 320 does not include a/the (first) UE identity list for paging or the DU 174 does not support a/the (first) UE identity list for paging. In such cases, the CU 172 does not include a/the UE (first) identity list for paging in the CU-to-DU Paging message of the event 320, because the CN-to-BS message of the event 318 does not include a/the (first) UE paging list or the CU 172 does not support a/the (first) UE identity list for paging or a/the (first) UE paging list. In one implementation, the preconfigured DRX cycle value(s) include a minimum of the default paging DRX cycle value, the RAN paging cycle value, and/or the UE specific DRX cycle value. In another implementation, the preconfigured DRX cycle value(s) include the default paging DRX cycle value, the RAN paging cycle value, and/or the UE specific DRX cycle value.

In addition to the at least one first PO, the DU 174 in some implementations can transmit 324 at the paging message in at least one second PO in at least one second PF on the cell to page one or more UEs. In some implementations, the DU 174 determines the second PO(s) and second PF(s) for UEs operating in the other of the RRC_IDLE and RRC_INACTIVE states.

In some implementations, the DU 174 determines the second PO(s) and second PF(s) using a second identity index value (i.e., as “UE ID” in the formulas above), a second paging DRX cycle value (i.e., as “T” in the formulas above) and the formulas described above. In some implementations, the CU 172 can include the second UE identity index value and the second paging DRX cycle value in a second item of the one or more items in the first UE identity list for paging. Alternatively, the CU 172 can transmit 321 a CU-to-DU Paging message including a second UE identity list for paging. The second UE identity list for paging includes one or more items and one of the one or more items includes the second UE identity index value and the second paging DRX cycle value. In some implementations, the first UE paging list includes the second UE identity index value and second paging DRX cycle value. In other implementations, the CU 172 determines the second UE identity index value based on the first UE ID. For example, the CU 172 sets the second UE identity index value to the first UE ID. In another example, the CU 172 uses a formula to derive the first UE identity index value with the first UE ID as an input of the formula. In yet other implementations, the CU 172 receives 319 from the CN 110 a CN-to-BS message including a second UE paging list, and the second UE paging list includes the second UE identity index value and second paging DRX cycle value. The CN-to-BS message of the event 319 can be a NGAP message defined in 3GPP specification 38.413. For example, the NGAP message is a Multicast Group Paging message. In yet other implementations, the CU 172 receives from the CN 110 a CN-to-BS message including the second paging DRX cycle value other than the CN-to-BS message of the event 319. For example, the CN-to-BS message is a NGAP message such as an Initial Context Setup Request message, a IJE Context Modification Request message, Handover Request message, or a Path Switch Request Acknowledge message. In one implementation, the second paging DRX cycle value is a UE specific DRX cycle value of the UE 102A that the CU 172 receives from the CN 110. In another implementation, the second paging DRX cycle value is a default paging DRX cycle value that the base station 104 uses or configures to page UEs.

In other implementations, the BS-to-BS message includes the first UE ID and/or second paging DRX cycle value. In one implementation, the second paging DRX cycle value is a UE specific DRX cycle value of the UE 102A that the second base station receives from the CN 110. In another implementation, the second paging DRX cycle value is a default paging DRX cycle value that the second base station (e.g., the base station 106) uses or configures for paging UEs.

In some implementations, the second PF(s) and first PF(s) partially or completely overlap. In other implementations, the second PF(s) and first PF(s) do not overlap. In some implementations, the second PO(s) and first PO(s) partially overlap. In other implementations, the second PO(s) and first PO(s) do not overlap.

In some implementations, the first PF(s) are included in multiple instances of a paging DRX cycle with a length set by the first paging DRX cycle value or the pre-configured paging DRX cycle value. Each of the multiple instances includes a particular PF of the first PF(s). The multiple instances can be consecutive. The DU 174 transmits the paging message in the first PO(s) in the first PF(s) in the multiple instances of the paging DRX cycle at event 322. In other implementations, the first PF(s) are included in multiple paging DRX cycles with lengths set by the pre-configured paging DRX cycle values. Each of the multiple paging DRX cycles has different DRX cycle lengths. In other words, the DU 174 transmits the paging message in the first PO(s) in the first PF(s) in the multiple paging DRX cycles at event 322. In yet other implementations, the first PF(s) are included in multiple instances of multiple paging DRX cycles with lengths set by the pre-configured paging DRX cycle values. Each of the multiple paging DRX cycles has different lengths. In other words, the DU 174 transmits the paging message in the first PO(s) in the first PF(s) in the multiple instances of the multiple paging DRX cycles at event 322. For each of the multiple paging DRX cycle, the multiple instances can be consecutive.

In some implementations, the DU 174 can transmit the paging message on a paging control channel (PCCH) in the first PO(s) and/or second PO(s). In some implementations, the DU 174 can generate a DCI and a CRC of the DCI to transmit the paging message on a PDCCH on each of the PDCCH monitoring occasion(s) in each of the first PO(s) and/or each of the second PO(s). The DCIs for transmission of the paging message in the PDCCH monitoring occasions can be the same or different. The DU 174 scrambles the CRC with a paging radio network temporary identifier (P-RNTI). The DU 174 can include a downlink assignment in the DCI, which indicates a radio resource for a transmission of the paging message. The DU 174 can transmit the DCI and the scrambled CRC on a PDCCH to the UE 102 and transmit the paging message on the indicated radio resource.

When the UE 102 receives the DCI and the scrambled CRC on a PDCCH in a PDCCH occasion in one of the first PO(s) or one of the second PO(s), the UE 102 verifies the scrambled CRC with the P-RNTI. If the UE 102 verifies the scrambled CRC is valid, the UE 102 receives or attempts to receive 322 or 324 the paging message on the radio resource in accordance with the DCI. After or in response to receiving 322 or 324 the paging message, the UE 102 can perform 328 an RRC connection resume procedure to activate (e.g., initiate) reception of the MBS session identified by the MBS session ID. In some implementations, the UE 102 can perform 326 a random access procedure with the DU 174 to perform the RRC connection resume procedure.

In some implementations, the UE 102 transmits an RRC resume request message (e.g., RRCResumeRequest message) to the CU 172 via the DU 174 to perform the RRC connection resume procedure. In cases where the random access procedure is a four-step random access procedure, the UE 102 transmits a Message 3 including the RRC resume request message to the DU 174, which in turn transmits the RRC resume request message to the CU 172. In cases where the random access procedure is a two-step random access procedure, the UE 102 transmits a Message A including the RRC resume request message to the DU 174, which in turn transmits the RRC resume request message to the CU 172. In response to the RRC resume request message, the CU 172 transmits an RRC resume message (e.g., RRC Resume message) to the UE 102 via the DU 174. In response to the RRC resume message, the UE 102 transitions 330 to an RRC_CONNECTED state and the MM-CONNECTED state (i.e., without an RRC inactive indication) and transmits an RRC resume complete message (e.g., RR (′ResumeComplete message) to the CU 172 via the DU 174. After or in response to transitioning the UE 102 to the RRC_CONNECTED state, the CU 172 transmits 332 to the CN 110 an RRC_Inactive Transition Report message indicating the UE 102 enters the RRC_CONNECTED state. The CN 110 determines 334 that the UE 102 operates in the MM-CONNECTED mode (i.e., without an RRC inactive indication).

After the CN 110 determines that the UE 102 operates in the MM-CONNECTED mode (i.e., without an RRC inactive indication) at event 334, the CN 110 transmits 336 MBS data packets to the CU 172 (or the CU-UP of the CU 172). The CU 172 in turn transmits 338 the MBS data packets to the DU 174. The DU 174 transmits 340 the MBS data packets to the UE 102 via multicast. In some implementations, the CU 172 generates PDCP PDUs each including a particular MBS data packet of the MBS data packets and transmits the PDCP PDUs to the DU 174 at event 338. The DU 174 generates MAC PDUs including the PDCP PDUs and transmits the MAC PDUs to the UE 102 at event 340. Each of the MAC PDUs can include a particular PDCP PDU of the PDCP PDUs or a portion of a PDCP PDU.

In some implementations, the DU 174 generates multicast configurations to configure MBS data reception on the cell 124 and transmits a DU-to-CU message (e.g., UJE Context Modification Required message, UJE Context Modification Response message or UJE Context Setup Response message) including the multicast configurations to the CU 172. In one implementation, the CU 172 includes the multicast configurations and/or MRB configuration(s) configuring MRB(s) in the RRC resume message. In another implementation, the CU 172 transmits RRC reconfiguration message(s) including the multicast configurations and/or MRB configuration(s) to the UE 102 at the event 304. The UE 102 retains the multicast configurations after (i.e., in response to) receiving the RRC release message at the event 310 and while the UE 102 operates 314 in the RRC_INACTIVE state. At event 340, the DU 174 transmits the MBS data packets (e.g., the MAC PDUs or PDCP PDUs) in accordance with the multicast configurations and the UE 102 receives the MBS data packets from the DU 174 in accordance with the multicast configurations and the MRB configuration(s).

Events 302, 304, 308, 310, 312, 314, 316, 326, 328, 332, 330, 334 are UE-specific. That is, these events occur for each of the UE 102A and UE 102B.

Turning next to FIG. 4, in a scenario 400, the UE 102 initially operates 414 in the RRC_INACTIVE state and MM-CONNECTED mode with an RRC inactive indication and the UF 103 initially operates 415 in the RRC_IDLE and MM-IDLE mode. The UE102 operates in the 414 in the RRC_INACTIVE state and MM-CONNECTED mode with an RRC inactive indication, similar to the event 314. Correspondingly, the CN 110 determines 416 that the UE 102 operates in the MM-CONNECTED mode with an RRC inactive indication, similar to the event 316. Correspondingly, the CN 110 determines 417 that the UE 103 operates in the MM-IDLE mode.

The CN 110 transmits 418 to the CU 172 a CN-to-BS message including a MBS session to notify UEs of activation of an MBS session identified by the MBS session, similar to the event 318. After (e.g., in response to) receiving the CN-to-BS message of the event 418, the CU 172 transmits 420 a CU-to-DU message to DU 174, similar to the event 320. The DU 174 can transmit 422 a paging message in at least one first PO in at least one first PF on a cell (e.g., cell 124), similar to the event 322. The DU 174 can transmit 424 the paging message in at least one second PO in at least one second PF on the cell, similar to the event 324.

After or in response to receiving 422 or 424 the paging message, the UE 102 can perform 428 an RRC connection resume procedure to activate (e.g., initiate) reception of the MBS session identified by the MBS session ID, similar to the event 328. In some implementations, the UE 102 can perform 426 a random access procedure with the DU 174 to perform the RRC connection resume procedure, similar to the event 326.

After or in response to receiving 422 or 424 the paging message, the UE 103 performs 427 an RRC connection establishment procedure with the CU 172 via the DU 174. In some implementations, the UE 103 can perform 425 a random access procedure with the DU 174 to perform the RRC connection establishment procedure, similar to the event 326. The UE 103 transitions 431 to the RRC_CONNECTED state and MM-CONNECTED mode (i.e., without an RRC inactive indication), in response to the RRC connection establishment procedure.

To perform the RRC connection establishment procedure, the UE 103 transmits an RRC setup request message (e.g., RRCSetupRequest message) to the CU 172 via the DU 174. In cases where the random access procedure is a two-step random access procedure, the UE 103 transmits to the DU 174 the RRC setup request message in a Message A of the two-step random access procedure. In cases where the random access procedure is a four-step random access procedure, the UE 103 transmits the RRC setup request message in a Message 3 of the four-step random access procedure. In turn, the DU 174 transmits the RRC setup request message to the CU 174. In response to the RRC setup request message, the CU 172 can transmit an RRC setup message (e.g., RR (Setup message) to the UE 103 via the DU 174. In response, the UE 103 transitions 431 to the RRC_CONNECTED state and transmits an RRC setup complete message (e.g., RRCSetupComplete message) to the CU 172 via the DU 174.

In some implementations, the UE 103 configures a first SRB (e.g., SRB1) to communicate RRC messages with the CU 172 (via the DU 174) in response to the RRC setup message. In such implementations, the UE 103 transmits the RRC setup complete message via the first SRB and the DU 174 to the CU 172. After transitioning 431 to the RRC_CONNECTED state, the UE 103 can send a Service Request message to the CN 110 via the DU 174 and CU 172 to establish a NAS signaling connection. In one implementation, the UE 103 can include the Service Request message in the RRC setup complete message. The CU 172 retrieves the Service Request message from the RRC setup complete message sends 429 a BS-to-CN message (e.g., Initial UE Message message) including the Service Request message to the CN 110. After successfully transmitting the Service Request message, the UE 103 transitions 431 to the MM-CONNECTED mode from the MM-IDLE mode. After receiving the BS-to-CN message at event 429, the CN 110 determines 442 that the UE 103 operates in the MM-CONNECTED mode.

After performing the RRC connection establishment procedure with the UE 103, the CU 172 can perform 433 a security activation procedure (e.g., RRC security mode procedure) with the UE 103 via the DU 174 to activate security (e.g., integrity protection/integrity check and/or encryption/decryption) on communication with the UE 102. In details, the CU 172 can transmit a security activation command message (e.g., SecurityModeCommand message) to the UE 103, e.g., via the first SRB and the DU 174, to perform 433 the security activation procedure. In response, the UE 103 activates security (e.g., integrity protection and/or encryption) on communication with the CU 172 and transmits a security activation complete message (e.g., SecurityModeComplete message) to the CU 172, e.g., via the first SRB and the DU 174. After activating the security, the CU 172 can perform 435 at least one RRC reconfiguration procedure with the UE 102 via the DU 174 to configure a second SRB (e.g., SRB2), DRB(s) and/or MRB(s) to exchange RRC messages, unicast data and/or multicast data with the UE 103, respectively. In some implementations, the CU 172 can receive multicast configurations from the DU 174 as described for FIG. 3, include the multicast configurations and MRB configuration(s) configuring the MRB(s) in RRC reconfiguration message(s) in the RRC reconfiguration procedure(s), and transmit the RRC reconfiguration message(s) to the UE 103. In some implementations, the CU 172 transmits the multicast configurations and/or MRB configuration(s) to the UE 102 in an RRC resume message of the RRC connection resume procedure. In other implementations, the CU 172 transmits RRC reconfiguration message(s) including the multicast configurations and/or MRB configuration(s) to the UE 102 when the UE 102 operated in the RRC_CONNECTED state before the event 414.

After the UE 102 and 103 transitions to the MM-CONNECTED mode, the CN 110 transmits 436 MBS data packets to the CU 172 (or the CU-UP of the CU 172). The CU 172 in turn transmits 438 the MBS data packets to the DU 174. The DU 174 transmits 440 the MBS data packets to the UE 102 and UE 103 via multicast. Events 436, 438 and 440 are similar to the events 336, 338 and 340. The UE 102 and 103 receive 440 the MBS data packets in accordance with the multicast configurations and MRB configuration(s).

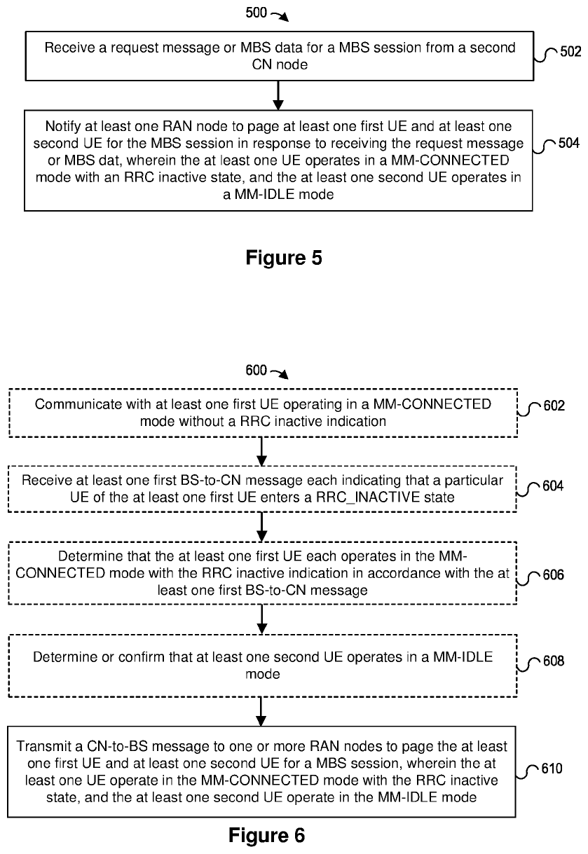

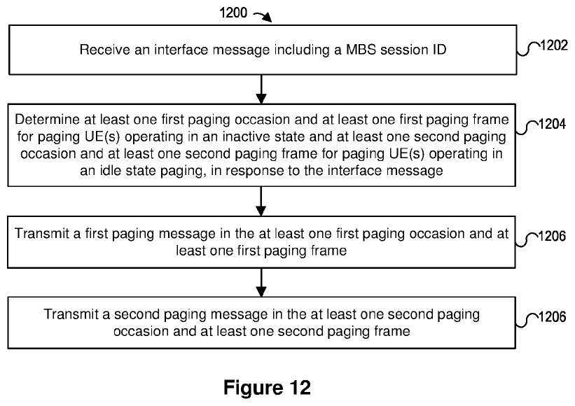

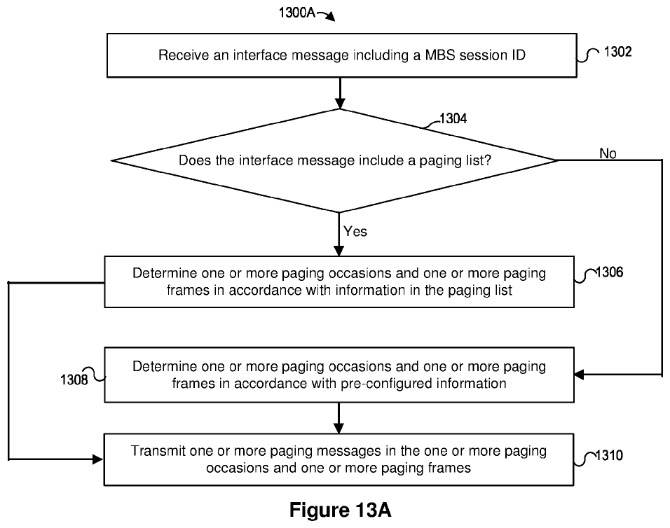

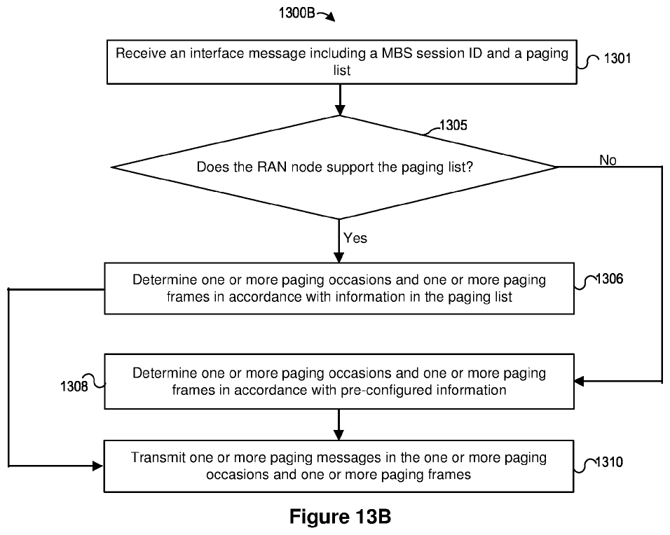

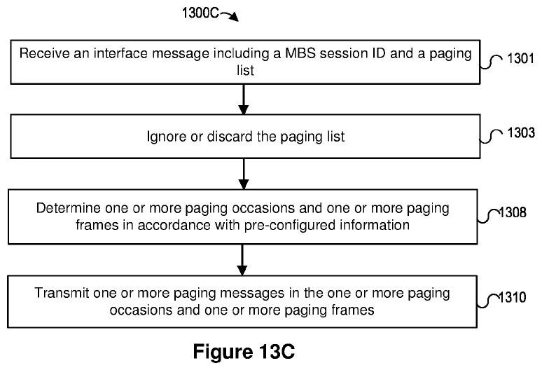

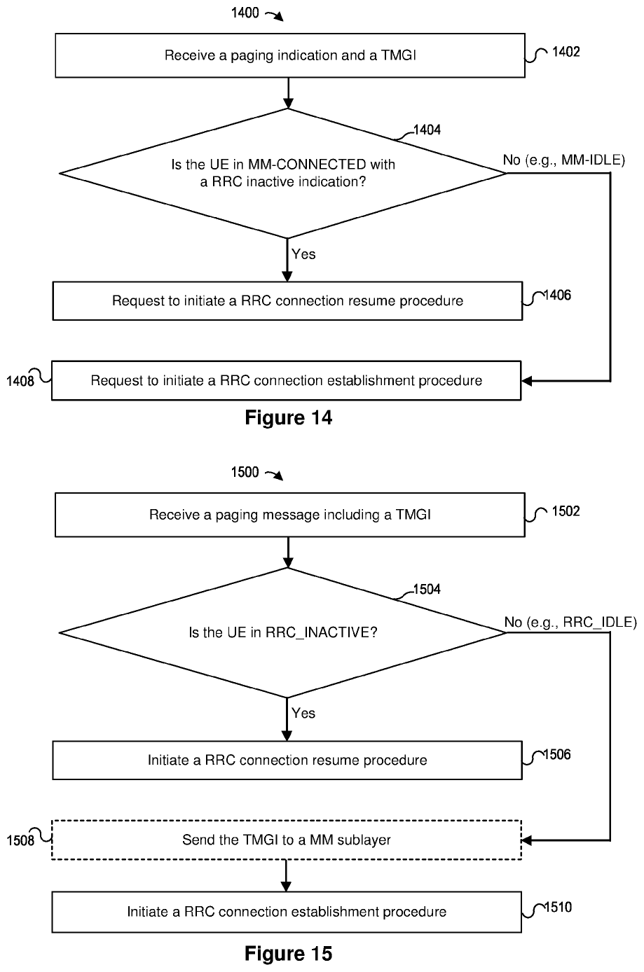

FIGS. 5-9C are flow diagrams depicting example methods that a CN node (e.g., the CN 110 or AMF 164) can implement to page UEs for an MBS session. FIGS. 10 and 11 are flow diagrams depicting example methods that a RAN node (e.g., the base station 104, CU 172 or CU-CP 172A) can implement to page UEs for an MBS session. FIGS. 12-13B are flow diagrams depicting example methods that a RAN node (e.g., the base station 104 or DU 174) can implement to page UEs for an MBS session. FIGS. 14 and 15 are flow diagrams depicting example methods that a UE can implement to receive a paging for an MBS session.

FIG. 5 is a flow diagram of an example method 500 for paging UEs for an MBS session. At block 502, a first CN node receives a request message for an MBS session from a second CN node. In some implementations, the request message includes an MBS session ID. In one implementation, the MBS session ID can be a Temporary Mobile Group Identity (TMGI). In some implementations, the first CN node is an AMF (e.g., the AMF 164), and the second CN node is SMF (the SMF 166) or MB-SMF (e.g., the MB-SMF 166). In some implementations, the request message is a Namf_MT_EnableGroupReachability request message. In other implementations, the request message is a Namf_MBSCommunication_N2Message Transfer request message.

At block 504, the first CN node notifies at least one RAN node to page at least one first UE and at least one second UE for the MBS session in response to receiving the request message, where the at least one UE operates in the MM-CONNECTED with the RRC inactive state, and the at least one second UE operates in the MM-IDLE state (e.g., events 38, 418).

FIG. 6 is a flow diagram of an example method 600 for paging UEs for an MBS session. At block 602, the CN node communicates with at least one first UE operating in an MM-CONNECTED mode without an RRC inactive indication. At block 604, the CN node receives at least one first BS-to-CN message each indicating that a particular UE of the at least one first UE enters an RRC_INACTIVE state (e.g., event 312). At block 606, determines that the at least one first UE operates in the MM-CONNECTED with the RRC inactive indication in accordance with the at least one first BS-to-CN message (e.g., events 316, 416). At block 608, the CN node determines or maintains that at least one second UE operates in an MM-IDLE mode (e.g., event 417). At block 610, the CN node transmits a CN-to-BS message to one or more RAN nodes to page the at least one first UE and at least one second UE for a MBS session, wherein the at least one UE operate in the MM-CONNECTED mode with the RRC inactive state, and the at least one second UE operate in the MM-IDLE mode (e.g., events 318, 418).

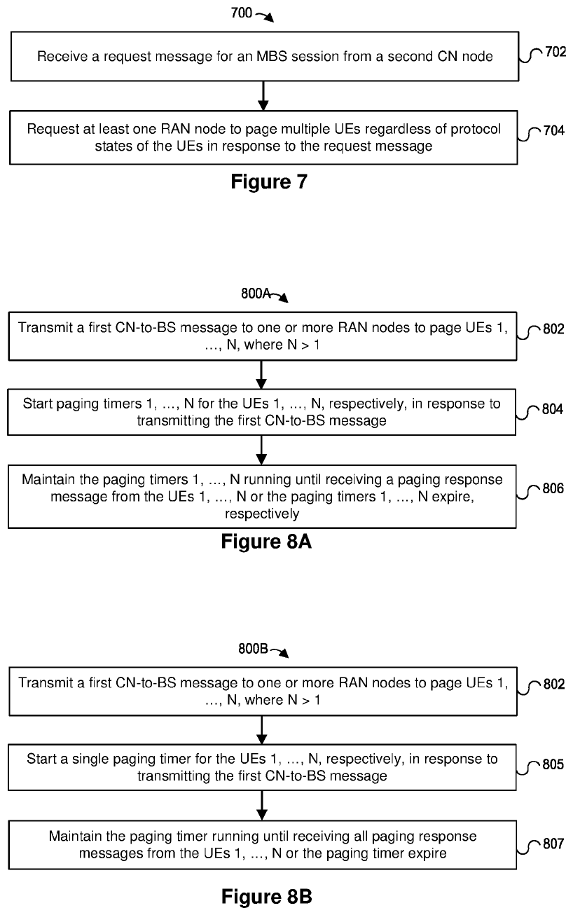

FIG. 7 is a flow diagram of an example method 700 for paging UEs an MBS session. At block 702, a first CN node receives a request message for an MBS session from a second CN node. At block 704, the first CN node notifies at least one RAN node to page multiple UEs regardless of protocol modes of the UEs in response to the request message (e.g., events 318, 418). In some implementations, the first CN node does not check a protocol state for any UE when the first CN node determines to page multiple UEs for the MBS session. In some implementations, the protocol modes (or states) include the MM-CONNECTED mode with an RRC inactive state and the MM-IDLE mode. In some implementations, the protocol modes may further include the MM-CONNECTED mode (i.e., without an RRC inactive indication). Examples and implementations described for FIG. 5 can apply to FIG. 7.

Same blocks in FIGS. 8A-8B are labeled with the same reference numbers.

FIG. 8A is a flow diagram of an example method 800A for paging UEs for an MBS session. At block 802, the CN node transmits a first CN-to-BS message to one or more RAN nodes to page UEs 1, . . . . N, where N>1 (e.g., events 318, 319, 418, 419). At block 804, the CN node starts paging timers 1, . . . , N for the UEs 1, . . . , N, respectively, in response to transmitting or determining to transmit the first CN-to-BS message. At block 806, the CN node maintains the paging timers 1, . . . , N running until receiving a paging response message from the UEs 1, . . . , N or the paging timers 1, . . . , N expire, respectively.

In some implementations, the paging timers are instances of a timer T3513. In other implementations, the paging timers are instances of a new timer defined in 3GPP specification 24.501 or in a 3GPP specification for 6G. In some implementations, the CN node receives a paging response message from UE M of the UEs 1, . . . , N via one of the one or more RAN nodes, where 0<M<N+1. The CN node stops the paging timer M in response to the paging response message. The CN node maintains the other paging timers 1, . . . , M−1, M. 1, . . . , N running if the CN node does not receive paging response messages from the UEs 1, . . . , M−1, M. I . . . , N.

In some implementations, the CN node includes a first UE paging list in the first CN-to-BS message. In one implementation, the CN can include, in the first UE paging list, UE identity index values 1, . . . , N indicating UE IDs 1, . . . , N of the UEs 1, . . . , N, respectively. In another implementation, the CN node includes, in the first UE paging list, paging DRX cycle configurations 1, . . . , N for the UEs 1 . . . , N, respectively. Each of the one or more RAN nodes can determine paging occasions based on the UE identity index values 1 . . . . N and/or paging DRX cycle configurations 1, . . . , N and transmit a paging message on the paging occasions.

In other implementations, the CN node does not include a UE paging list in the first CN-to-BS message. In such implementations, each of the one or more RAN nodes transmits a paging message on paging occasion(s) in one or more paging cycles determined by the each RAN node.

If one, some or all of the paging timers 1, . . . , N expire(s), the CN node can transmit a second CN-to-BS message to the one or more RAN nodes to request the one or more RAN nodes to page some of the UEs 1, . . . , N that have not connected to the CN node. In some implementations, the CN node includes a second UE paging list in the second CN-to-BS message. In one implementation, the CN can include, in the second UE paging list, UE identity index values indicating UE IDs of the UEs where the expired paging timer(s) is/are associated. The CN node can include, in the second UE paging list, paging DRX cycle values for the UEs where the expired paging timer(s) is/are associated. Thus, each of the one or more RAN nodes can determine paging occasions based on the UE identity index values and/or paging DRX cycle values and transmit paging message(s) on the paging occasions, as described for FIG. 3. The paging message(s) can include a MBS session ID of the MBS session. In some implementations, the paging messages are the same paging message. In other implementations, some of the paging messages include one or more UE IDs and some of the paging messages do not include a UE ID.

In other implementations, the CN node does not include a UE paging list in the second CN-to-BS message. In such implementations, each of the one or more RAN nodes transmits paging message(s) on paging occasion(s) in one or more paging cycles determined by the each RAN node, as described for FIG. 3. The paging message(s) can include a MBS session ID of the MBS session. In other implementations, some of the paging messages include one or more UE IDs and some of the paging messages do not include a UE ID.

FIG. 8B is a flow diagram of an example method 800B, similar to the method 800A, except that the method 800B includes blocks 805 and 807 instead of blocks 804 and 806. At block 805, the CN node starts a single paging timer for the UEs 1, . . . , N, respectively, in response to transmitting the first CN-to-BS message. At block 807, the CN node maintains the paging timer running until receiving all paging response messages from the UEs 1. . . . N or the paging timer expire.

In some implementations, if the paging timer expires, the CN node can transmit a second CN-to-BS message to the one or more RAN nodes to request the one or more RAN nodes to page some of the UEs 1, . . . , N that have not connected to the CN node, as described for FIG. 8A.

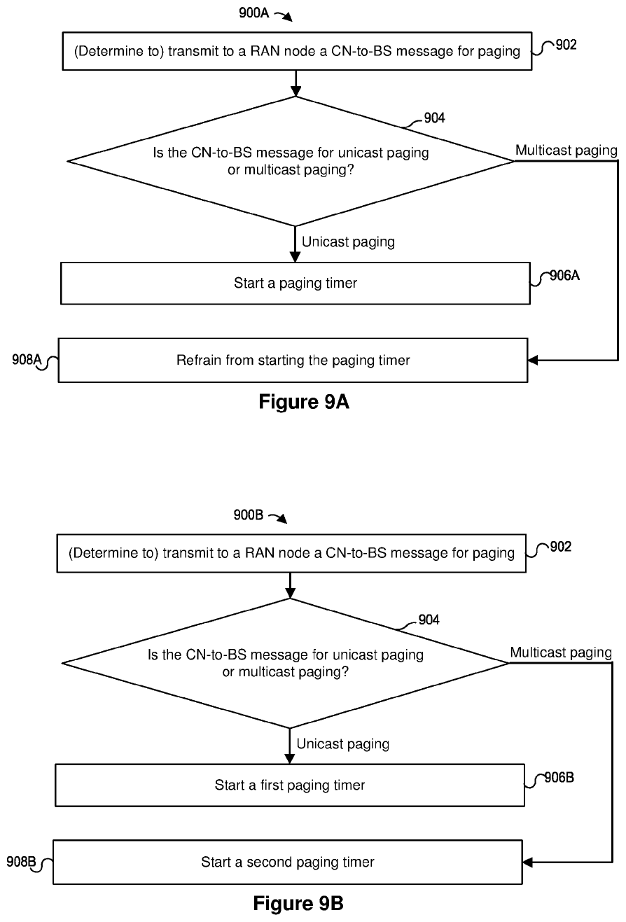

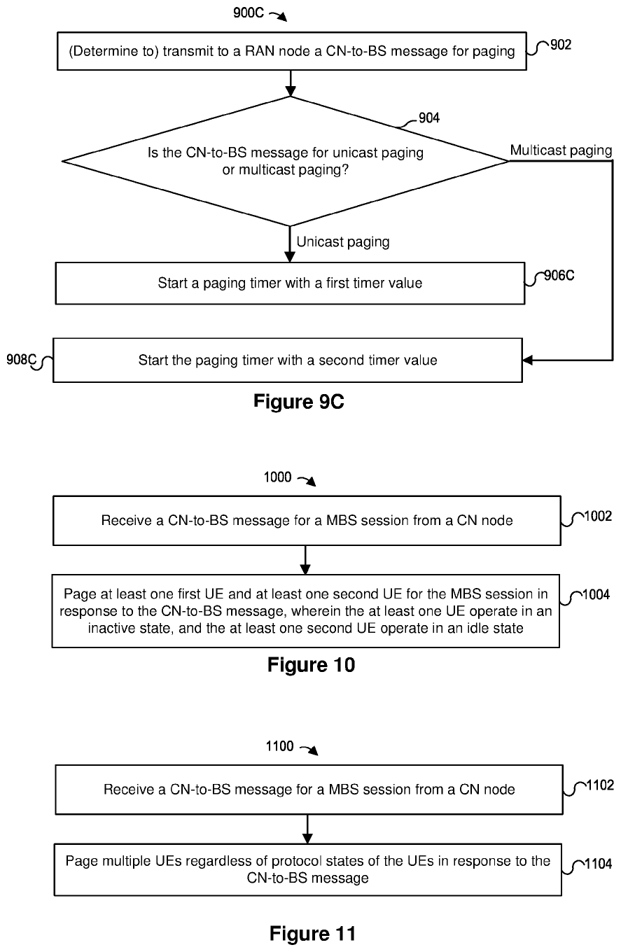

Same blocks in FIGS. 9A-9C are labeled with the same reference numbers.

FIG. 9A is a flow diagram of an example method 900A for paging UE for an MBS session. At block 902, the CN node determines to transmit or transmits to a RAN node a CN-to-BS message for paging (e.g., events 318, 418). At block 904, the CN node determines whether the CN-to-BS message is for unicast paging or multicast paging. If the CN node determines that the CN-to-BS message (e.g., the first instance of the CN-to-BS message) is for unicast paging, the flow proceeds to block 906A. At block 906A, the CN node starts a (single) paging timer in response to transmitting or determining to transmit the CN-to-BS message. Otherwise, if the CN node determines that the CN-to-BS message (e.g., the second instance of the CN-to-BS message) is for multicast paging, the flow proceeds to block 908A. At block 908A, the CN node refrains from starting the paging timer.

In some implementations, if the CN node receives a NAS message from the UE to respond the paging, the CN node stops the paging timer. If the paging timer expires, the CN node can transmit the CN-to-BS message to the RAN node or another RAN node to page the UE.

FIG. 9B is a flow diagram of an example method 900B, similar to the method 900A, except that the method 900B includes blocks 906B and 908B instead of blocks 906A and 908A. If the CN node determines that the CN-to-BS message (e.g., the first instance of the CN-to-BS message) is for unicast paging, the flow proceeds to block 906B. At block 906B, the CN node starts a first paging timer, similar to block 906A. Otherwise, if the CN node determines that the CN-to-BS message (e.g., the second instance of the CN-to-BS message) is for multicast paging, the flow proceeds to block 908B. At block 908B, the CN node starts a second paging timer, similar to block 805 of FIG. 8B. In some implementations, the first paging timer can be a timer T3513 and the second paging timer is a timer other than the timer T3513. For example, the second paging timer is a new timer defined in 3GPP specification 24.501. Examples and implementations described for FIGS. 8B and 9A can apply to FIG. 9B.

In some implementations, the CN node starts the first paging timer and second paging timer with the same timer value. In other implementations, the CN node starts the first paging timer and second paging timer with a first timer value and a second timer value, respectively. In some implementations, the first timer value and second timer value are different. In one implementation, the first timer value is smaller than the second timer value because the MBS session can take or tolerate a longer time to wait for multiple UEs to respond the multicast paging.

FIG. 9C is a flow diagram of an example method 900C, similar to the methods 900A and 900B, except that the method 900C includes blocks 906C and 908C instead of blocks 906A-B and 908A-B. If the CN node determines that the CN-to-BS message (e.g., the first instance of the CN-to-BS message) is for unicast paging, the flow proceeds to block 906C. At block 906C, the CN node starts a paging timer with a first timer value, similar to block 906A. Otherwise, if the CN node determines that the CN-to-BS message (e.g., the second instance of the CN-to-BS message) is for multicast paging, the flow proceeds to block 908C. At block 908C, the CN node starts the paging timer with a second timer value, similar to block 906A of FIG. 9A. In some implementations, the paging timer is a timer T3513 defined in 3GPP specification 24.501.

In some implementations, the first timer value and second timer value are different. In one implementation, the first timer value is smaller than the second timer value because the MBS session can take or tolerate a longer time to wait for multiple UEs to respond the multicast paging.

FIG. 10 is a flow diagram of an example method 1000 for paging UE for an MBS session. At block 1002, a RAN node receives a CN-to-BS message for a MBS session from a CN node (e.g., events 318, 418). In some implementations, the RAN node is a base station (e.g., the base station 104) or a CU (e.g., CU 172 or CU-CP 172A), and the CN node is an AMF (e.g, the AMF 164). At block 1004, the RAN node pages at least one first UE and at least one second UE for the MBS session in response to the CN-to-BS message, wherein the at least one UE operate in an inactive state, and the at least one second UE operate in an idle state (e.g., events 320, 322, 321, 324, 420, 422, 421, 424). In some implementations, the inactive state and idle state are RRC_INACTIVE state and RRC_IDLE state, respectively.

FIG. 11 is a flow diagram of an example method 1100 for paging UE for an MBS session. At block 1102, a RAN node receives a CN-to-BS message for a MBS session from a CN node (e.g., events 318, 418). In some implementations, the RAN node is a base station (e.g., the base station 104) or a CU (e.g., CU 172 or CU-CP 172A), and the CN node is an AMF (e.g, the AMF 164). At block 1104, the RAN node pages multiple UEs regardless of protocol states of the UEs in response to the CN-to-BS message (e.g., events 320, 322, 321, 324, 420, 422, 421, 424). In some implementations, the protocol states include RRC_INACTIVE state and RRC_IDLE state. In one implementation, the protocol states can further include RRC_CONNECTED state.

FIG. 12 is a flow diagram of an example method 1200 for paging UEs for an MBS session. At block 1202, a RAN node receives an interface message including an MBS session ID (e.g., events 318, 320, 319, 321, 418, 420, 419, 421). At block 1204, the RAN node determines at least one first paging occasion and at least one first paging frame for paging UE(s) operating an inactive state and at least one second paging occasion and at least one second paging frame for paging UE(s) operating in an idle state, in response to the interface message. At block 1206, the RAN node transmit a first paging message in the at least one first paging occasion and at least one first paging frame (e.g., events 318, 320, 322, 418, 420, 422). At block 1208, the RAN node transmit a second paging message in the at least one second paging occasion and at least one second paging frame (e.g., events 321, 324, 421, 424).

Examples and implementations described for FIGS. 3 and 4 can apply to FIG. 12.

Same blocks in FIGS. 13A-14B are labeled with the same reference numbers.

FIG. 13A is a flow diagram of an example method 1300A for paging UEs for an MBS session. At block 1302, a RAN node receives an interface message including a MBS session ID (e.g., events 318, 320, 319, 321, 418, 420, 419, 421). At block 1304, the RAN node determines whether the interface message includes a paging list. If the RAN node determines that the interface message (e.g., the first instance of the interface message) includes a paging list, the flow proceeds to block 1306. At block 1306, the RAN node determines one or more paging occasions and one or more paging frames in accordance with information in the paging list. Otherwise, if the RAN node determines that the interface message (e.g., the second instance of the interface message) does not include a paging list, the flow proceeds to block 1308. At block 1308, the RAN nodes determines one or more paging occasions and one or more paging frames in accordance with pre-configured information. The flow proceeds to block 1310 from block 1306 as well as block 1308. At block 1310, the RAN node transmits one or more paging message in the one or more paging occasions and one or more paging frames (e.g., events 322, 324, 422, 424).

In some implementations, the RAN node at block 1306 determines one or more instances of one or more paging DRX cycles in accordance with in the information in the UE paging list, and the RAN node at block 1310 transmits the one or more paging messages in the one or more paging occasions and one or more paging frames in the one or more instances of the one or more paging DRX cycles. In some implementations, the RAN node at block 1308 determines one or more instances of one or more paging DRX cycles in accordance with the pre-configured information, and the RAN node at block 1310 transmits the one or more paging messages in the one or more paging occasions and one or more paging frames in the one or more instances of the one or more paging DRX cycles.

In some implementations, the information in the paging list include one or more items each include a UE identity index value and/or a paging DRX cycle value. If one of the one or more items does not include a paging DRX cycle value, the RAN node can use a pre-configured paging DRX cycle value. In some implementations, the pre-configured information includes pre-configured UE identity index value(s) and pre-configured paging DRX cycle value(s).

In some implementations, in cases where the interface message is a CN-to-BS message (e.g., events 318, 319, 418, 419), the paging list is a UE paging list. In some implementations, in cases where the interface message is a CN-to-DU message (e.g., events 320, 321, 420, 421), the paging list is a UE identity list for paging.

FIG. 13B is a flow diagram of an example method 1300B, similar to the method 1300A, except that the method 1300B includes blocks 1301 and 1305 instead of blocks 1302 and 1304.

At block 1301, the RAN node receives an interface message including a MBS session ID and a paging list (e.g., events 318, 320, 319, 321, 418, 420, 419, 421). At block 1305, the RAN node determines the RAN node supports a paging list. If the RAN node determines that the RAN node supports the paging list, the flow proceeds to block 1306. Otherwise, if the RAN node determines that the RAN node does not support the paging list, the flow proceeds to block 1308.

FIG. 13C is a flow diagram of an example method 1300C, similar to the methods 1300A and 1300B, except that the method 1300C includes block 1303 instead of block 1305.

At block 1303, the RAN node ignores or discard the paging list. That is, the RAN node at block 1308 determines one or more paging occasions and one or more paging frames in accordance with pre-configured information, regardless of whether a received interface message for paging UEs for an MBS session includes a paging list.

FIG. 14 is a flow diagram of an example method 1400 for receiving paging for an MBS session. At block 1402, an MM sublayer (e.g., the MM sublayer 214) of a UE receives a paging indication and a TMGI, e.g., from a lower layer (e.g., an RRC sublayer such as the RRC sublayer 213) of the UE. At block 1404, the MM sublayer determines whether the UE is in an MM-CONNECTED mode with an RRC inactive indication. If the MM sublayer determines that the UE is in the MM-CONNECTED mode with an RRC inactive indication, the flow proceeds to block 1406. At block 1406, the MM sublayer requests to initiate an RRC connection resume procedure (e.g., events 328, 428). In some implementations, the MM sublayer layer requests the lower layer to initiate the RRC connection resume procedure. Otherwise, if the MM sublayer determines that the UE is in an MM-IDLE mode, the flow proceeds to block 1408. At block 1408, the MM sublayer requests to initiate an RRC connection establishment procedure (e.g., event 427). In some implementations, the MM sublayer layer requests the lower layer to initiate the RRC connection establishment procedure.

In some implementations, lower layer can send a single message including the paging indication and TMGI to the MM sublayer. In some implementations, the “TMGI” can be replaced by a “MBS session ID”. In some implementations, the MM sublayer determines to stay in the MM-CONNECTED mode with an RRC inactive indication in response to receiving the paging indication and TMGI. In some implementations, the MM sublayer determines the paging indication with the TMGI is a RAN paging when the MM sublayer is in the MM-CONNECTED mode with an RRC inactive indication. After (e.g., in response to) completing the RRC connection resume procedure (e.g., receiving an RRC resume message or transmitting an RRC resume complete message), the lower layer sends a first lower layer indication to the MM sublayer. The MM sublayer transitions to the MM-CONNECTED mode (i.e., without an RRC inactive indication) in response to the first lower layer indication. In some implementations, the MM sublayer determines to stay in the MM-IDLE mode in response to receiving the paging indication and TMGI. In some implementations, the MM sublayer determines the paging indication with the TMGI is a CN paging or AMF paging when the MM sublayer is in the MM-IDLE mode. After (e.g., in response to) completing the RRC connection establishment procedure (e.g., receiving an RRC setup message or transmitting an RRC setup complete message) or transmitting a NAS message (e . . . , a Service Request message), the lower layer sends a second lower layer indication to the MM sublayer. The MM sublayer transitions to the MM-CONNECTED mode (i.e., without an RRC inactive indication) in response to the second lower layer indication.

FIG. 15 is a flow diagram of an example method 1500 for receiving paging for an MBS session. At block 1502, a UE receives a paging message including a TMGI, e.g., from a RAN node (e.g., the DU 174 or base station 104) (e.g., events 322, 324, 422, 424). At block 1504, the UE determines whether the UE is in an RRC_INACTIVE state. If the UE determines that the UE is in the RRC_INACTIVE state, the flow proceeds to block 1506. At block 1506, the RRC sublayer initiates an RRC connection resume procedure (e.g., events 328, 428). Otherwise, if the UE determines that the UE is in an RRC_IDLE state, the flow proceeds to blocks 1508 (optional) and 1510. At block 1508, an RRC sublayer (e.g., the RRC sublayer 213) of the UE sends the TMGI to an MM sublayer of the UE. At block 1510, the UE initiates an RRC connection establishment procedure (e.g., event 427).

In some implementations, the RRC sublayer of the UE perform actions described in blocks 1502, 1504, 1506 and 1510. In some implementations, the RRC sublayer sends the TMGI to the MM sublayer to indicate paging for the TMGI, i.e., a paging indication with the TMGI as described for FIG. 14.

The following additional considerations apply to the foregoing discussion.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IF” is used and can be replaced by “field”, and vice versa. In some implementations, “configuration” can be replaced by “configurations” or “configuration parameters”, and vice versa. In some implementations, “MBS” can be replaced by “MBS session” or vice versa. In some implementations, the “MBS session ID” can be replaced by “MBS session IDs” or “TMGI”, and the “MBS session” can be replaced by “MBS sessions”. The “MM” can be replaced by “5GMM”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A paging method performed by a node of a radio access network (RAN), the method comprising:
receiving a message including an identifier of a multicast and/or broadcast services (MBS) session;
in a first instance, in response to determining that the message includes a UE paging list, paging a user equipment (UE) using a UE identity index (UE ID) value included in the paging list; and
in a second instance, in response to determining that the message does not include a UE paging list, paging the UE in a plurality of paging occasions (POs), using pre-configured information.

2. (canceled)

3. The method of claim 1, wherein:
the paging of the UE using the pre-configured information includes using one or more pre-configured paging cycles.

4. The method of claim 1, wherein:
the paging of the UE using the pre-configured information includes using a pre-configured identity index (UE ID) value.

5. (canceled)

6. The method of claim 1, wherein the paging of the UE using the UE ID value includes:
determining a paging frame (PF) for the paging using the UE ID value; and
transmitting a paging message in the PF.

7. The method of claim 6, wherein the paging of the UE using the UE ID value includes:
determining a PO for the paging using the UE ID value; and transmitting the paging message in the PO.

8. The method of claim 7, further comprising:
broadcasting, in a cell in which the UE operates, system information including an indication of the PO, the PO including one or more Physical Downlink Control Channel (PDCCH) occasions.

9. The method of claim 1, wherein the paging of the UE using the UE ID value includes:
using a discontinuous reception (DRX) cycle included in the UE paging list.

10. The method of claim 1, wherein the message is a Multicast Group Paging message.

11. The method of claim 10, wherein:
the node of the RAN is a distributed unit (DU) of a distributed base station, and
the message is received from a central unit (CU) of the distributed base station.

12. (canceled)

13. The method of claim 1, further comprising:
determining a first PO for paging one or more UEs operating in an idle state of a radio resource control (RRC) protocol; and
determining a second PO for paging one or more UEs operating in an inactive state of the RRC protocol.

14. The method of claim 13, further comprising:
determining a first PF associated with the first PO; and
determining a second PF associated with the second PO.

15. A radio access network (RAN) node comprising:
a transceiver; and
processing hardware; the RAN node configured to:
receive a message including an identifier of a multicast and/or broadcast services (MBS) session,
in a first instance, in response to determining that the message includes a UE paging list, paging a user equipment (UE) using a UE identity index (UE ID) value included in the paging list, and
in a second instance, in response to determining that the message does not include a UE paging list, paging the UE in a plurality of paging occasions (POs), using pre-configured information.

16. The RAN node of claim 15, wherein to page of the UE using the pre-configured information, the RAN node is configured to:
use one or more pre-configured paging cycles.

17. The RAN node of claim 15, wherein to page of the UE using the pre-configured information, the RAN node is configured to:
use a pre-configured identity index (UE ID) value.

18. The RAN node of claim 15, wherein to page of the UE using the UE Is value, the RAN node is configured to:
determine a paging frame (PF) for the paging using the UE ID value; and
transmit a paging message in the PF.

19. The RAN node of claim 18, wherein to page of the UE using the UE Is value, the RAN node is configured to:
determine a PO for the paging using the UE ID value, and
transmit the paging message in the PO.

20. The RAN node of claim 19, further configured to:
broadcast, in a cell in which the UE operates, system information including an indication of the PO, the PO including one or more Physical Downlink Control Channel (PDCCH) occasions.

21. The RAN node of claim 15, wherein to page of the UE using the UE Is value, the RAN node is configured to:
use a discontinuous reception (DRX) cycle included in the UE paging list.

22. The RAN node of claim 15, wherein:
the message is a Multicast Group Paging message.

23. The RAN node of claim 15, further configured to:
determine a first PO for paging one or more UEs operating in an idle state of a radio resource control (RRC) protocol, and
determine a second PO for paging one or more UEs operating in an inactive state of the RRC protocol.
